(19) United States
(12) Patent Application Publication
(10) Pub. No.: US 2015/0344234 A1
(43) Pub. Date: Dec. 3, 2015

(54) ROTATING APPARATUS

(71) Applicants: BOE Technology Group Co., Ltd., Beijing (CN); Beijing BOE Display Technology Co., Ltd., Beijing (CN)

(72) Inventors: Hui Liu, Beijing (CN); Yuzhu Hou, Beijing (CN); Zhenqi You, Beijing (CN)

(21) Appl. No.: 14/471,286

(22) Filed: Aug. 28, 2014

(30) Foreign Application Priority Data
May 30, 2014 (CN) 201410241126.8

(51) Int. Cl. B65G 47/248

(52) U.S. Cl. CPC B65G 47/248

(57) ABSTRACT

The present disclosure provides a rotating apparatus. It comprises a supporter configured to support and rotate glass; and a servo-motor arranged at a central position of the supporter and configured to support the supporter and to raise or lower the supporter.

### CROSS-REFERENCE TO RELATED APPLICATION

This application claims the benefit of Chinese Patent Application No. 201410241126.8 filed on May 30, 2014 in the State Intellectual Property Office of China, the whole disclosure of which is incorporated herein by reference.

### BACKGROUND OF THE INVENTION

1. Field of the Invention

The present disclosure relates to a rotating apparatus.

2. Description of the Related Art

In the process of producing a liquid crystal panel, glass may be inversed when it is transported in forward direction. In the prior art, by scanning 2D code on the glass with an automated optical inspection (AOI), it is determined, on basis of the scanning results, whether the glass is inversed or not; if the 2D code is not scanned, it will send out alarm to indicate the inversion of the glass.

When the glass is inversed in traveling direction, the AOI will not be performed. Instead, the inversed glass has to be detected and turned over manually in the downstream production line and the process for the glass will be reworked. In this way, the waste of materials will occur in the upstream production line and the down time of the production line will be increased so as to reduce throughput.

### SUMMARY OF THE INVENTION

In view of the above and other problems in the prior, an embodiment of the present invention provides a rotating apparatus, and the rotating apparatus comprises a supporter configured to support and rotate glass, and a servo-motor arranged at a central position of the supporter and configured to support the supporter and to raise or lower the supporter.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic view showing a structure of a rotating apparatus according to an embodiment of the present invention;

FIG. 2 is a schematic view showing a structure of another rotating apparatus according to an embodiment of the present invention;

FIG. 3 is a schematic view showing a structure of a further rotating apparatus according to an embodiment of the present invention;

FIG. 4 is a schematic view showing a structure of a further rotating apparatus according to an embodiment of the present invention;

FIG. 5 is a schematic view showing a structure of a rotating apparatus according to an embodiment of the present invention; and

FIG. 6 is a schematic view showing a structure of another rotating apparatus according to an embodiment of the present invention.

Reference Numerical: 1—supporter; 11—first straight rod; 12—second straight rod; 13—No. 1 straight rod; 14—No. 2 straight rod; 15—No. 3 straight rod; 16—No. 4 straight rod; 2—servo-motor; 3—vacuum sucker; 4—spacer; 5—frame; 6—pulley.

### DETAILED DESCRIPTION OF PREFERRED EMBODIMENTS OF THE INVENTION

The embodiments of the present invention will be further explained below with reference to the figures and examples. The following embodiments are only explained by way of examples, instead of being intended to limit the scope of the present invention.

In accordance with a general invention concept of the present disclosure, a rotating apparatus is provided, and the rotating apparatus comprises a supporter configured to support and rotate glass; and a servo-motor arranged at a central position of the supporter and configured to support the supporter and to raise or lower the supporter. In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

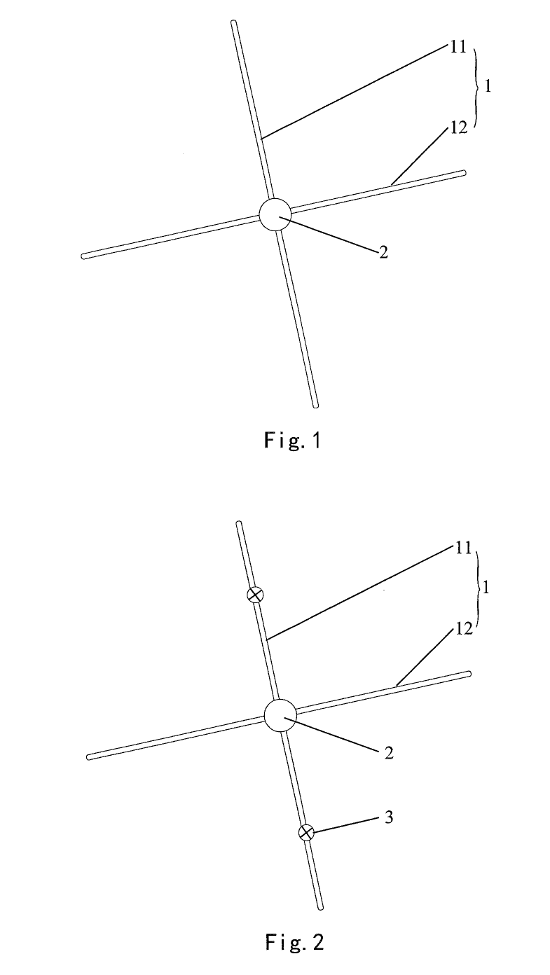

An embodiment of the present invention provides a rotating apparatus. With reference to FIG. 1, the apparatus includes a supporter 1 and a servo-motor 2. The supporter 1 is configured to support and rotate glass. The servo-motor 2 is arranged at a central position of the supporter 1 and configured to support the supporter 1 and to raise or lower the supporter 1.

As illustrated in FIG. 1, according to an embodiment of the present invention, the supporter 1 includes a first straight rod 11 and a second straight rod 12 crossing perpendicularly with each other at the central positions of them.

The first straight rod 11 and the second straight rod 12 may both be formed from materials with low weight and high strength, for example, materials with high strength and low density such as aluminum alloy, light section.

The shapes and sizes of the first straight rod and the second straight rod are not limited as long as they can ensure the glass to rest on the supporter stably. In the actual production line, the shapes and sizes of the first straight rod and the second straight rod may be determined on basis of factors such as size of glass and product cost.

The servo-motor 2 is located at the central position of the supporter 1.

The inversed glass may be placed on the supporter of the rotating apparatus and rotated by the rotating apparatus to the original direction.

In particular, when the glass is inversed, the rotating apparatus is moved from the original position to the position of the glass and the glass is moved to the supporter of the rotating apparatus by a clamping apparatus on the production line, and then the servo-motor raises the supporter of the rotating apparatus to a position from the product table by a certain distance and turns the inversed glass back to the original direction according to the received instructions. When no inversion of glass occurs on the production line, the rotating apparatus is not needed and the servo-motor may lower the supporter of the rotating apparatus to the position which will not interfere with the production line.

The rotating apparatus according to an embodiment of the present invention may be applied in the production line of the liquid crystal panel and mounted in the upstream production line of the AOI inspection apparatus in each production line and process timely the inversed glass. In this way, it may solve the problem that the glass is inversed in forward direction in the product process of the liquid crystal panel in the prior art, so as to avoid shut-down of the production line, to reduce the product costs and to improve the production rate. In addition, the production efficiency of the production line may also be improved.

Further, with reference to FIG. 2, according to an embodiment of the present invention, the rotating apparatus may further include at least one pair of vacuum sucker 3. As illustrated in FIG. 2, two vacuum suckers 3 are arranged on the first straight rod 11. The vacuum suckers 3 are configured to fix the glass on the supporter 1. The two vacuum suckers 3 are centrally symmetrical with respect to the central position.

According to an embodiment of the present invention, the vacuum suckers 3 may be made from aging resistant rubber materials. The number of the vacuum suckers is not limited. However, at least two vacuum suckers are needed such that the glass is fixed stably on the supporter when the rotating apparatus rotates the glass to prevent the glass from falling due to too high speed in the process of raising, lowering or rotating the rotating apparatus. In practical application, the number of the vacuum suckers may be determined according to the size of the glass in the practical production line and the product requirements as long as the number of the vacuum suckers may ensure the glass can be fixed securely on the supporter while the glass is balanced on the supporter. Certainly, in order to ensure the balance of the glass, the number of the vacuum suckers must be even number.

As an example, FIG. 2 shows a pair of vacuum suckers, i.e., two vacuum suckers.

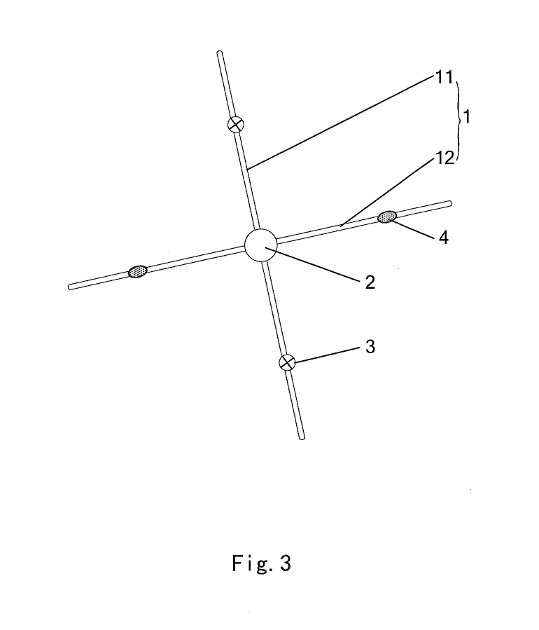

In an embodiment, with reference to FIG. 3, the rotating apparatus further includes at least one pair of spacers 4 arranged on the supporter 11 and configured to separate the glass from the supporter 11. The spacers 4 are arranged on the second straight rod 12. As shown in FIG. 3, the spacers 4 are provided in the position which is different from that of the vacuum suckers 3. In an example, the vacuum suckers 3 are arranged on the first straight rod 11 while the spacers 4 are arranged on the second straight rod 12. Two vacuum suckers 4 are centrally symmetrical with respect to the central position.

As an example, the spacers may be made from low weight and high strength, for example, stable and wear resistant materials such as resin type or carbon fiber type. The spacers separate the glass from the supporter to keep a certain distance between the glass and the supporter to avoid the damage of the glass caused by too large contact area. The shapes of the spacers are not limited. The shapes of the spacers shown in Figures are only used to indicate the positions of them instead of limiting their shapes. As an example, they may have shapes that have relative small contact area with the glass and ensure the glass to be placed stably. The number of the spacers is also not limited, but the number may at least ensure balance of the glass when it is placed on the spacers. In practice, the number of the spacers may be determined by the size of the glass in the production line and actual requirements. However, in order to keep balance of the glass, the number of the spacers must be even number.

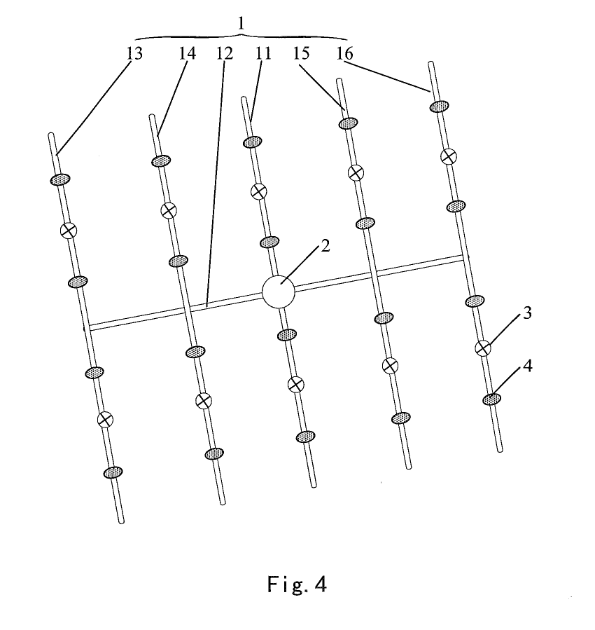

In an embodiment, with reference to FIG. 4, the supporter 1 further includes N straight rods 13, 14, 15, 16 . . . , where each of the N straight rods crosses perpendicularly with the second straight rod 12 at its central position, and N is a positive integer.

As an example, the distance between two adjacent straight rods is equal to the distance between the first straight rod and the one of the N straight rods next to the first straight rod 11.

As illustrated in FIG. 4, the supporter 1 further includes four straight rods, twenty spacers 4 and twelve vacuum suckers 13. No. 1 straight rod 13 crosses perpendicularly with the second straight rod 12 at the central position of the No. 1 straight rod 13. No. 2 straight rod 14 crosses perpendicularly with the second straight rod 12 at the central position of the No. 2 straight rod 14. No. 3 straight rod 15 crosses perpendicularly with the second straight rod 12 at the central position of the No. 3 straight rod 15. No. 4 straight rod 16 crosses perpendicularly with the second straight rod 12 at the central position of the No. 4 straight rod 16.

Further, the distance between the No. 1 straight rod 13 and the No. 2 straight rod 14 and the distance between the No. 3 straight rod 15 and the fourth straight rod 16 are both equal to the distance between the first straight rod 11 and the straight rod 14 or 15 next to the first straight rod 11.

As an example, the N straight rods may be made from the same materials as those of the first straight rod and the second straight rod, i.e., the structural materials with low weight and high strength, for example, materials with high strength and low density such as aluminum alloy, light section. All of the N straight rods have a same length. The shape and length of each of them is not limited, as an example, it may be same to those of the first straight rod. The value of N may be determined on basis of factors such as size of the glass in the practical production line, production costs and production benefits. Generally, the smaller the size of the glass becomes, the less the number of the required straight rods becomes, i.e., the smaller the value of N is.

With reference to FIG. 4, it shows a plurality of vacuum suckers 3 and a plurality of spacers 4 arranged on the straight rods. On the No. 1 straight rod 13, arranged two vacuum suckers 3 and four spacers 4. The vacuum suckers 3 are centrally symmetrical with respect to the No. 1 straight rod 13 and the spacers 4 are centrally symmetrical with respect to the No. 1 straight rod 13.

As an example, the servo-motor 2 may be an up-and-down screw servo-motor.

In particular, in the example, the up-and-down screw servo-motor may ensure the stability of the entire rotating apparatus in the ascent process or the descent process. A typical up-and-down motor may cause the entire apparatus to fall suddenly in its ascent process or fall rapidly until the bottom in its descent process due to insufficient pressure. In this way, the glass may be damaged such that the entire production may not be work normally. In contrast, in the up-and-down screw servo-motor, the ascent and descent of the supporter are both achieved by controlling screws. The height and speed of the ascent or descent may be controlled efficiently by the operator such that the rotating apparatus may be raised or lowered stably to avoid the unexpected damage of the glass.

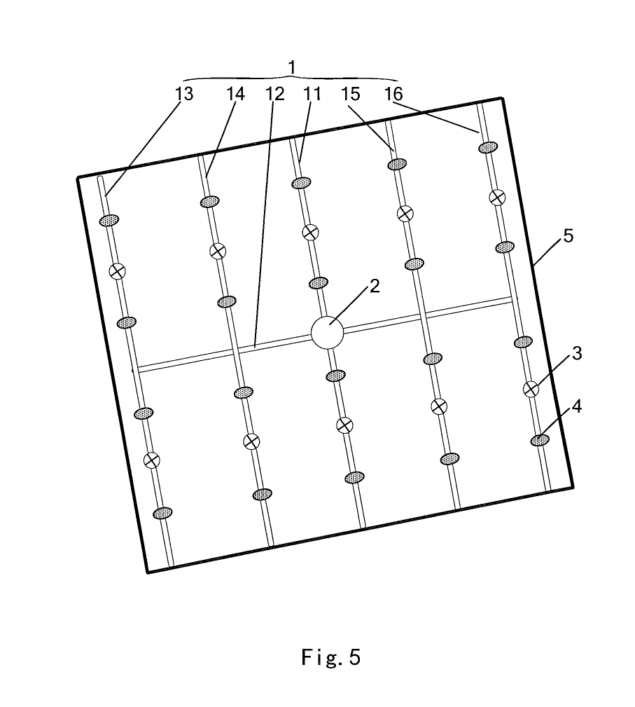

In an embodiment, with reference to FIG. 5, the rotating apparatus further includes a frame 5. The frame 5 is connected to an end of the supporter and configured to fix the supporter within the frame.

In an example, the rotating apparatus including the frame may be clamped easily by a clamping apparatus such that the rotating apparatus may be used conveniently and rapidly. The skilled person in the art may select suitable materials as those of the frame such that the frame made from the materials may meet the above requirement without increasing the production cost.

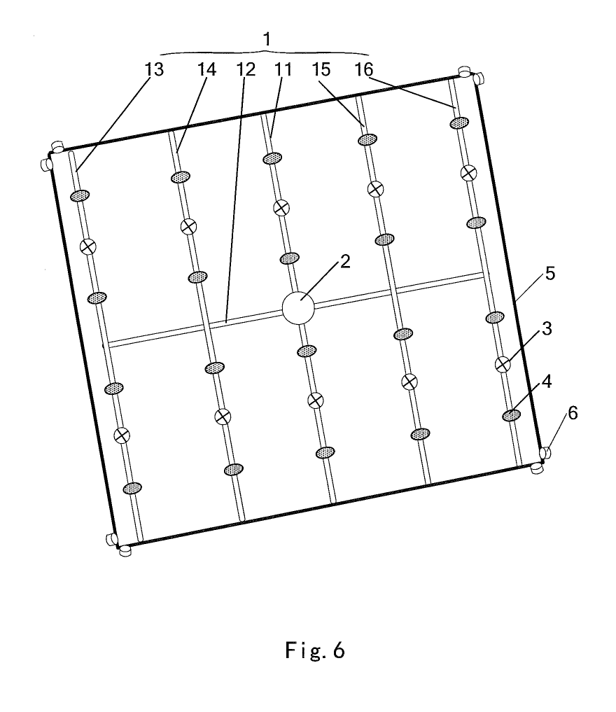

In an embodiment, as shown in FIG. 6, the rotating apparatus further includes rollers 6 arranged at corners of the frame and configured to allow the rotating apparatus to slide.

The rollers 6 may allow the rotating apparatus to be used easily in the production line. When the rotating apparatus falls from the space to the production table, the rollers are actuated automatically to roll to the desired positions. The skilled person in the art may select suitable materials as those of the frame such that the frame made from the materials may meet the above requirement without increasing the production cost.

The rotating apparatus according to an embodiment of the present invention may be applied in the production line of the liquid crystal panel and mounted in the upstream production line of the AOI inspection apparatus in each production line and process timely the inversed glass. In this way, it may solve the problem that the glass is inversed in forward direction in the product process of the liquid crystal panel in the prior art, so as to avoid shut-down of the production line, to reduce the product costs and to improve the production rate. In addition, the production efficiency of the production line may also be improved.

Although several exemplary embodiments have been shown and described, the present invention is not limited to those and it would be appreciated by those skilled in the art that various changes or modifications may be made in these embodiments without departing from the principles and spirit of the disclosure, which should fall within the scope of the present invention. The scope of the invention is defined in the claims and their equivalents.

What is claimed is:

1. A rotating apparatus comprising
a supporter configured to support and rotate glass; and
a servo-motor arranged at a central position of the supporter and configured to support the supporter and to raise or lower the supporter.

2. The rotating apparatus according to claim 1, wherein the supporter comprises a first straight rod and a second straight rod crossing perpendicularly with each other at the central positions of them.

3. The rotating apparatus according to claim 1, wherein the rotating apparatus further comprises at least one pair of vacuum suckers arranged on the supporter and configured to fix the glass onto the supporter.

4. The rotating apparatus according to claim 3, wherein the rotating apparatus further comprises at least one pair of spacers arranged on the supporter and configured to separate the glass from the supporter, the spacers being provided in the position which is different from that of the vacuum suckers.

5. The rotating apparatus according to claim 4, wherein all of spacers in each pair of the spacers are centrally symmetrical with respect to the central position of the supporter.

6. The rotating apparatus according to claim 3, wherein all of suckers in each pair of the suckers are centrally symmetrical with respect to the central position of the supporter.

7. The rotating apparatus according to claim 6, wherein the rotating apparatus further comprises at least one pair of spacers arranged on the supporter and configured to separate the glass from the supporter, the spacers being provided in the position which is different from that of the vacuum suckers.

8. The rotating apparatus according to claim 7, wherein all of spacers in each pair of the spacers are centrally symmetrical with respect to the central position of the supporter.

9. The rotating apparatus according to claim 2, wherein the rotating apparatus further comprises at least one pair of vacuum suckers arranged on the supporter and configured to fix the glass onto the supporter.

10. The rotating apparatus according to claim 9, wherein the rotating apparatus further comprises at least one pair of spacers arranged on the supporter and configured to separate the glass from the supporter, the spacers being provided in the position which is different from that of the vacuum suckers.

11. The rotating apparatus according to claim 10, wherein all of spacers in each pair of the spacers are centrally symmetrical with respect to the central position of the supporter.

12. The rotating apparatus according to claim 9, wherein all of suckers in each pair of the suckers are centrally symmetrical with respect to the central position of the supporter.

13. The rotating apparatus according to claim 12, wherein the rotating apparatus further comprises at least one pair of spacers arranged on the supporter and configured to separate the glass from the supporter, the spacers being provided in the position which is different from that of the vacuum suckers.

14. The rotating apparatus according to claim 13, wherein all of spacers in each pair of the spacers are centrally symmetrical with respect to the central position of the supporter.

15. The rotating apparatus according to claim 2, wherein the supporter further comprises N straight rods, each of which crosses perpendicularly with the second straight rod at its central position, N being a positive integer; and
wherein the distance between two adjacent straight rods is equal to the distance between the first straight rod and the one of the N straight rods next to the first straight rod.

16. The rotating apparatus according to claim 1, wherein the servo-motor is an up-and-down screw servo-motor.

17. The rotating apparatus according to claim 1, wherein the rotating apparatus further comprises a frame connected to an end of the supporter and configured to fix the supporter within the frame.

18. The rotating apparatus according to claim 17, wherein the rotating apparatus further comprises rollers arranged at corners of the frame and configured to allow the rotating apparatus to slide.

19. The rotating apparatus according to claim 2, wherein the rotating apparatus further comprises a frame connected to an end of the supporter and configured to fix the supporter within the frame.

20. The rotating apparatus according to claim 19, wherein the rotating apparatus further comprises rollers arranged at corners of the frame and configured to allow the rotating apparatus to slide.
